(19) United States
(12) Patent Application Publication
(10) Pub. No.: US 2024/0158627 A1
(43) Pub. Date: May 16, 2024

(54) EPOXY RESIN COMPOSITIONS

(71) Applicant: HEXCEL COMPOSITES LIMITED, Duxford, Cambridgeshire (GB)

(72) Inventors: Martin Richard SIMMONS, Baldock, Hertfordshire (GB); Scott THOMPSON, Cambridge (GB); Stephen MORTIMER, St. Ives, Cambridgeshire (GB)

(73) Assignee: HEXCEL COMPOSITES LIMITED, Duxford, Cambridgeshire (GB)

(21) Appl. No.: 17/768,263

(22) PCT Filed: Sep. 22, 2020
(86) PCT No.: PCT/EP2020/076446

§ 371 Date: Apr. 12, 2022

(30) Foreign Application Priority Data
Nov. 1, 2019 (EP) 19206729.6

(51) Int. Cl. C08L 63/00; C08G 59/50; C08L 87/00

(52) U.S. Cl. CPC C08L 63/00; C08G 59/504; C08L 87/00; C08L 2205/035

(57) ABSTRACT

There is provided a resin composition for producing a composite part, comprising: a) from 30 to 90 wt % by weight of the composition of an epoxy resin component; and b) from 5 to 50 wt % by weight of the composition of a curative component; wherein the epoxy resin component comprises N,N,N′,N′-tetraglycidyl-4,4′-diamino-3,3′-dimethyldiphenylmethane (M-TGDDM) in an amount of at least 30 wt % by weight of the epoxy resin component; and further wherein the curative component comprises one or more of a diaminodiphenyl sulfone, a diaminobenzophenone, a fluorene diamine, a methylene bis aniline, including hybrid methylene bis anilines, or a substituted diamine toluene. There is also provided the use of N,N,N′,N′-tetraglycidyl-4,4′-diamino-3,3′-dimethyldiphenylmethane (M-TGDDM) as a compression performance improving additive in a resin composition for producing a composite part. There are also provided curable composite components, cured composite components produced therefrom and the use of such components as aircraft components.

The present invention relates to improved epoxy resin compositions and in particular to epoxy resin formulations that can be used for the production of composite components, particularly aircraft components, having improved compression properties. The invention also relates to the use of N,N,N′,N′-tetraglycidyl-4,4′-diamino-3,3′-dimethyldiphenylmethane (M-TGDDM) as a compression performance improving additive in epoxy resin formulations, and to curable and cured composite components comprising M-TGDDM.

Composite materials are typically composed of a resin matrix and reinforcing fibers as the two primary constituents. The resin matrix will generally comprise one or more thermosetting or thermoplastic resins and one or more curing agents. Composite materials are often required to perform in demanding environments, such as in the field of aerospace where the physical limits and characteristics of the composite part is of critical importance. It is critical that such composite parts have particular strengths in tension and in compression. Furthermore, given the uses to which the composites are put, it is also important that they retain a particular strength at locations where holes may be formed for attachments.

Various tests have been developed to assess the strength of fibre reinforced composite material, one of which is known as the open hole compression test (OHC), which is the test adopted as the standard test for locations where holes have been formed in the composites, such as for securing attachments. This test is widely used, particularly in the aerospace industry to judge the acceptability of materials, and is the ACEMA standard pr EN 6036. It is also important that the composite materials maintain desired in use properties when fasteners are applied, and a further method has been developed for testing such properties, namely the filled hole compression test (FHC), which may be tested, for example, using ASTM D6742/D6742M-17.

Fibre reinforced composites that are based on thermosetting resins are typically produced employing one of two basic processes. In one process a material known as a prepreg is formed by impregnating a layer of fibrous material which may be woven or nonwoven unidirectional or multidirectional with an uncured or partially cured liquid resin. The prepreg is then shaped as required for the finished article and the resin cured, usually by heat to form the high strength light weight finished product. The resins used in these systems are typically epoxy resins, cyanate ester resins or bismaleimide resins and the resin formulation usually contains a curative for the particular resin.

In an alternative manufacturing technique a fibrous material is laid up, generally within an enclosure, into which a liquid resin system can be infused to envelope the fibrous material, where it may then be cured to produce the finished article. The enclosure may be complete around the fibrous material and the resin drawn in under vacuum (sometimes known as the vacuum bag technique). Alternatively the enclosure may be a mould, and the resin may be injected into the mould (sometimes known as Resin Transfer Moulding), which may also be vacuum assisted (known as Vacuum Assisted Resin Transfer Moulding). As with the earlier described system in relation to prepregs, the liquid resin system may be an epoxy resin, a cyanate ester resin or a bismaleimide resin, and it will also contain a curative for the particular resin.

Tetrafunctional epoxy resins are widely used in resin compositions for forming aerospace components, either alone or in combination with difunctional and/or trifunctional epoxy resins, and N,N,N′,N′-tetraglycidyl-4-4-diaminodiphenylmethane (TGDDM) (also known as tetraglycidyl-4,4′-methylene dianiline (TGMDA)) is a very well know resin component, providing a good balance of processing and end properties. N,N,N′,N′-tetraglycidyl-4-4-diethyl-3-3′-diaminodiphenylmethane (E-TGDDM) is also used in resin compositions, sometimes in combination with TGDDM, and is known to have a lower viscosity than TGDDM, which can be useful both in infusion-type resins (e.g. to improve flow during the infusion process) and in prepreg-type resins (e.g. to improve processability). E-TGDDM has lower reactivity than TGDDM when used in similar compositions, which can result in longer outlife (i.e. increased storage time before the resin begins to deteriorate). However, replacing TGDDM with an equivalent amount of E-TGDDM gives a cured matrix with a lower Tg when compared to the use of TGDDM alone, and such resin compositions may even not be curable using standard cure cycles, such as 2 hours at 180° C. Furthermore, although the use of E-TGDDM can provide relatively increased compression modulus for neat resin, this does not translate to improved compression performance in composite materials, for example when tested using the OHC or FHC tests. N,N,N′,N′-tetraglycidyl-4,4′-diamino-3,3′-dimethyldiphenylmethane (M-TGDDM) is also a known resin component, but it is not known to provide any improvements in resin composition properties compared to TGDDM or E-TGDDM. In particular, as E-TGDDM does not lead to improved compression modulus performance in composite material properties despite providing higher compression modulus in neat resin tests, there is no reason to assume that M-TGDDM could produce any such improvements.

The structure of N,N,N′,N′-tetraglycidyl-4,4′-diamino-3,3′-dimethyldiphenylmethane (M-TGDDM) is shown below:

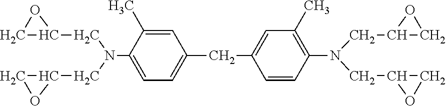 [SMILES: Cc1cc(Cc2ccc(N(CC3CO3)CC3CO3)c(C)c2)ccc1N(CC1CO1)CC1CO1]

Even relatively small changes in the nature or proportions of the epoxy components used in resin compositions can have large effects on the properties of the cured components formed from the compositions, and changes intended to improve one particular property often produce deleterious effects on one or, frequently, many other properties of the composition.

The present invention aims to obviate or at least mitigate the above described problems and/or to provide improvements generally.

According to the invention there is provided a composition, a use, a curable composite component, a cured composite component and the use of a cured composite component according to any of the accompanying claims.

The present invention provides a resin composition for producing a composite part, comprising:
a) from 30 to 90% by weight of the composition of an epoxy resin component; and
b) from 5 to 50% by weight of the composition of a curative component;
   wherein the epoxy resin component comprises N,N,N′,N′-tetraglycidyl-4,4′-diamino-3,3′-dimethyldiphenylmethane (M-TGDDM) in an amount of at least 30 wt % by weight of the epoxy resin component;
   and further wherein the curative component comprises one or more of a diaminodiphenyl sulfone, a diaminobenzophenone, a fluorene diamine, a methylene bis aniline, including hybrid methylene bis anilines, or a substituted diamine toluene.

The present invention further provides The use of N,N,N′,N′-tetraglycidyl-4,4′-diamino-3,3′-dimethyldiphenylmethane (M-TGDDM) as a compression performance improving additive in a resin composition for producing a composite part.

The present invention further provides a curable composite component comprising reinforcement fibres and a formulation according to the present invention, a cured composite component obtainable by curing a curable composite component of the present invention and the use of a cured composite component of the present invention as an aircraft component.

We have found that the use of M-TGDDM in resin compositions for producing composite parts provides a number of benefits, particularly in resins intended for use in producing aerospace parts, and particularly when used to partially or fully replace TGDDM and or E-TGDDM. These benefits are provided in resins intended for use in resin infusion systems and also in resins for use in preimpregnated materials, such as prepregs and semi-pregs.

For resins used in resin infusion systems, the benefits of including M-TGDDM include reduced viscosity at injection temperatures, leading to better flow and impregnation, and also allowing for the incorporation of additional components that would otherwise unacceptably increase the viscosity of the resin. Additionally, the use of M-TGDDM can increase potlife of the resin before infusion, i.e. allowing the retention of stable viscosity at a range of temperatures, including from 80° C. to 120° C., so that viscosity does not increase sufficiently to make resin injection difficult or even impossible, and therefore making storage easier and/or allowing longer storage.

For resins used in prepregs the benefits of including M-TGDDM include longer room temperature outlife of the preimpregnated material, again making storage easier and/or allowing longer storage. Additionally, the use of M-TGDDM in resins for prepregs provides better processability due to lower viscosity and lower reactivity.

In both infusion resins and prepreg resin, a further advantage provided by the use of M-TGDDM is higher compression performance in neat resin.

A particularly useful advantage provided by the use of M-TGDDM in both infusion resins and prepreg resins is higher compression performance in cured composite parts, and this may include OHC, FHC, compression strength, compression modulus and/or compression after impact.

Tgs will be generally unchanged when substituting M-TGDDM in place of TGDDM.

N,N,N′,N′-tetraglycidyl-4,4′-diamino-3,3′-dimethyldiphenylmethane (M-TGDDM) is a dimethyl derivative of N,N,N′,N′-tetraglycidyl-4-4-diaminodiphenylmethane (TGDDM), which is also known as tetraglycidyl-4,4′-methylene dianiline (TGMDA) amongst other designations. M-TGDDM is a known material available from various sources.

In the compositions of the present invention, the epoxy resin component generally comprises from 30 to 85 wt % by weight of the composition, preferably from 35 to 80 wt %, more preferably from 40 to 70 wt %, and even more preferably from 45 to 65 wt %.

In the compositions of the present invention, the M-TGDDM is present in an amount of at least 30 wt % by weight of the epoxy resin component. In certain embodiments of the present invention, M-TGDDM is the sole epoxy resin component, and in such compositions it may therefore be present in an amount of up to 90 wt % by weight of the composition. In certain embodiments of the invention, the compositions comprise at least 10 wt % by weight of the composition M-TGDDM, preferably from 15 to 65 wt %, more preferably from 20 to 60 wt %.

In certain embodiments of the present invention the epoxy resin component further comprises N, N, N′, N′-tetraglycidyl-4-4-diaminodiphenylmethane (TGDDM), N, N,N′, N′-tetraglycidyl-4-4′-diethyl-3-3′-diaminodiphenylmethane (E-TGDDM) or a mixture thereof; however preferably the combined weight of TGDDM and/or E-TGDDM does not exceed twice the weight of the M-TGDDM. In preferred compositions according to this embodiment, the combined weight of TGDDM and/or E-TGDDM is from 10 to 60 wt % by weight of the composition, more preferably from 20 to 50 wt %.

In certain embodiments of the present invention, the epoxy resin component further comprises one or more non-TGDDM based resins in addition to the M-TGDDM and any TGDDM and/or E-TGDDM. In preferred compositions according to this embodiment, the combined weight of the non-TGDDM resins is from 5 to 60 wt % by weight of the composition, more preferably from 10 to 50 wt %. The amount of non-TGDDM resins includes any resins added to the compositions directly or indirectly, for example resins combined with, or as carriers for, other components.

Any conventional epoxy resins may be included in the compositions of the present invention as non-TGDDM based resin, including difunctional and multifunctional (trifunctional, tetrafunctional, etc.) epoxy resins, such as bisphenol based epoxy resins, epoxy novolac resins, naphthalene based epoxy resins, cyclopentadiene based epoxy resins, brominated epoxy resins and aminophenol based resins.

In preferred compositions of this embodiment the one or more non-TGDDM based resins comprise a multifunctional epoxy resin and/or a difunctional epoxy resin. Particularly suitable non-TGDDM based resins include triglycidyl-p-aminophenol (TGPAP), triglycidyl m-aminophenol (TGMAP), triglycidyl ether of 4-amino-3-methyl phenol, tetraglycidyl ether of m-xylxylenediam ine, N, N, N′, N′-tetraglycidyl-4-4′-dichloro-3-3′-diaminodiphenylmethane; diglycidyl ether of bisphenol A, diglycidyl ether of bisphenol F, diglycidyl ether of bisphenol Z, diglycidyl ether of bisphenol TMC, diglycidyl ether of thiodiphenol, cyclopentadiene based epoxy resin, naphthalene based epoxy resins, triglycidylether of tri(-hydroxyphenyl)methane and 9,9-bis[4-(glycidyloxy)phenyl]fluorene and mixtures thereof.

The compositions of the present invention generally comprise from 5 to 50 wt % by weight of the composition of a curative component, preferably from 10 to 45 wt % by weight of the composition, more preferably from 15 to 40 wt % by weight of the composition.

By a curative component is meant any component or combination of components that enables curing of the compositions of the present invention. The curative component of the compositions of the present invention comprises at least one of a diaminodiphenyl sulfone, a diaminobenzophenone, a fluorene diamine, a methylene bis aniline, including hybrid methylene bis anilines, or a substituted diamine toluene; or may comprise a mixture of any of these components. Examples of suitable curatives include 3,3-diaminodiphenyl sulfone 4,4-diaminodiphenyl sulfone, 3,3′-diaminobenzophenone, 4,4′-diaminobenzophenone, 9,9-Bis(3-chloro-4-aminophenyl)fluorene, 4,4-methylene bis (2,6-diethylaniline), 4,4-methylene bis (3-chloro-2,6-diethylaniline), 4,4′-methylene bis (2-ethyl-6-methylaniline), 4,4-methylene bis (2-isopropyl-6-methyleneaniline), 4,4′-methylene bis (2-chloroaniline), 4,4′-methylene— (diisopropyl)-(chloro-diethyl)-dianiline (M-DIPACDEA), 4,4′-methylene (methyl-ethyl)-(chloro-diethyl)-dianiline (M-MEACDEA), 4,4′-methylene (methyl-isopropyl)-(chloro-diethyl)-dianiline (M-MIPACDEA), diethyl toluene diamine, dimethylthiotoluenediamine or mixtures thereof.

The curative component used in the present invention may also comprise a further curative in combination with one or more of the above curatives, and may also include additional agents such as co-curatives or accelerators, i.e. components that enhance the performance of the curing agent or agents. Optional additional curatives or accelerators that may be used in combination with the above curatives include dicyandiamides and hydrazide curatives and/or urea based accelerators.

In certain embodiments of the present invention, the compositions may comprise one or more toughening agents, and in such embodiments the combined weight of the toughening agents is preferably from 1 to 45% by weight of the composition, more preferably from 2 to 40 wt %, and even more preferably from 3 to 30 wt %.

Suitable toughening agents for use in the compositions of the present invention comprise thermoplastic materials such as phenoxy resins, polyvinyl butyral resins, thermoplastic fluoropolymers, polyimides, ethylene vinyl acetate copolymers, poly(aryl ether sulfone), polyamide particles, core shell rubbers and epoxy-rubber adducts. Preferred toughening agents include thermoplastic polymers, such as polysulfones, polyethersulfones and polyetherimides (preferably in amounts of from 5 to 20 wt % by weight of the composition), polyamide particles, such as PA11, PA12, etc. (preferably in amounts of from 10 to 20 wt % by weight of the composition), and core shell rubbers, such as core-shell particles dispersed in a bisphenol F epoxy resin, e.g. MX136 (preferably in amounts of 1 to 15 wt %, more preferably 3 to 10 wt %), or mixtures thereof.

The formulations of the present invention may contain any other conventional additives, such as fire and smoke suppressants, flexibilizers, impact modifiers, polymer or copolymer fillers, and other elongation promoting additives, wetting, flow and levelling agents, and anti-settling agents.

According to the present invention, M-TGDDM may be used as a compression performance improving additive in a wide range of resin compositions that are suitable for producing composite parts; however M-TGDDM is particularly suitable for such a use in compositions comprising from 30 to 90 wt % by weight of the composition of an epoxy resin component (including the M-TGDDM) and from 5 to 50 wt % by weight of the composition of a curative component, particularly when M-TGDDM comprises at least 30 wt % by weight of the epoxy resin component on the composition. Particularly suitable compositions for the use of the present invention include compositions based on known TGDDM containing compositions in which the M-TGDDM is used to replace all or at least part of the TGDDM, preferably wherein at least a third of the TGDDM is replaced by M-TGDDM. In such uses, the M-TGDDM is preferably used in an amount of at least 30 wt % by weight of the total epoxy resin content of the composition; and more preferably as at least 10 wt % by weight of the composition, even more preferably from 15 to 65 wt %, and most preferably from 20 to 60 wt %. In such uses the curative preferably comprises at least one of a diaminodiphenyl sulfone, a diaminobenzophenone, a fluorene diamine, a methylene bis aniline, including hybrid methylene bis anilines, or a substituted diamine toluene; or it may comprise a mixture of any of these components

Preferably in the use of the present invention, the M-TGDDM is used in compositions having the preferred components and amounts set out herein with respect to preferred embodiments of the compositions of the invention.

By a compression performance improving additive it is meant that the incorporation of M-TGDDM in a composition leads to the resin having improved compression properties, and more especially to composite components formed from the resins exhibiting improvements in one or more compression characteristics, such as OHC, FHC, compression strength, compression modulus and/or compression after impact, when compared to corresponding resins having similar compositions but excluding M-TGDDM.

The curable composite components of the present invention may be produced by combining the compositions of the present invention with reinforcement fibres in any conventional way, for example by manufacturing prepregs or by resin infusion. The reinforcement fibres may be any suitable fibres, such as glass fibres, carbon fibres or aramid fibres, and may have any convenient fibre arrangements and properties.

The cured composite components of the present invention may be obtained by curing the curable composite components of the present invention in any convenient manner taking into account the properties and relative proportions of the resin and curative components. In general, for curable components of the invention in which the resin composition corresponds to a known resin composition in which the TGDDM component has been partially or fully replaced by M-TGDDM a curing schedule similar to, or the same as, the curing schedule used for the known resin composition will be suitable.

The cured composite components of the present invention may be used in any way that conventional cured components are used, but they are particularly useful as components that are to be used in situations in which good compression properties, such as OHC, FHC and compression after impact, properties are required. In particular, the cured components of the present invention are particularly suitable for use as aerospace components.

Examples of compositions according to the present inventions include the following compositions:

| | | Range | Example |
|---|---|---|---|
| Component | Example | wt % | wt % |
| Composition 1 | | | |
| M-TGDDM | M-TGDDM | 9-50 | 25 |
| TGDDM based resin | TGDDM | 0-30 | 15 |
| Multifunctional resin | TGPAP | 20-45 | 35 |
| Toughener | PES | 10-30 | 20 |
| Curative | Dicyandiamide | 1-20 | 5 |
| Composition 2 | | | |
| M-TGDDM | M-TGDDM | 9-70 | 50 |
| TGDDM based resin | TGDDM | 0-50 | 10 |
| Difunctional resin | Bisphenol A | 10-30 | 15 |
| Toughener | Phenoxy resin | 5-25 | 15 |
| Curative | Dicyandiamide | 1-10 | 5 |
| Curative | Diuron | 1-10 | 5 |
| Composition 3 | | | |
| M-TGDDM | M-TGDDM | 9-40 | 20 |
| TGDDM based resin | TGDDM | 0-30 | 10 |
| Multifunctional resin | TGPAP | 20-40 | 30 |
| Toughener | PES | 10-30 | 20 |
| Curative | 3,3-DDS | 10-30 | 20 |
| Composition 4 | | | |
| M-TGDDM | M-TGDDM | 9-20 | 15 |
| TGDDM based resin | TGDDM | 0-20 | 0 |
| Multifunctional resin | TGMAP | 10-30 | 15 |
| Difunctional resin | Bisphenol F | 5-25 | 15 |
| Toughener | PES | 5-25 | 15 |
| Toughener | Polyamide | 10-30 | 20 |
| Curative | 4,4-DDS | 10-30 | 20 |
| Composition 5 | | | |
| M-TGDDM | M-TGDDM | 9-70 | 50 |
| TGDDM based resin | TGDDM | 0-30 | 0 |
| Multifunctional resin | TGPAP | 5-25 | 13 |
| Toughener | PES | 10-30 | 20 |
| Curative | 4,4-DDS | 5-25 | 15 |
| Curative | Dicyandiamide | 0-5 | 2 |
| Composition 6 | | | |
| M-TGDDM | M-TGDDM | 9-60 | 35 |
| TGDDM based resin | TGDDM | 0-30 | 10 |
| Difunctional resin | Solid Bisphenol A | 5-20 | 10 |
| Toughener | Phenoxy resin | 1-15 | 5 |
| Toughener | Core shell rubber * | 10-30 | 25 |
| Curative | Diuron | 1-15 | 5 |
| Curative | ADH | 1-15 | 5 |
| Fire retardant | Red Phosphorous | 1-15 | 5 |
| Composition 7 | | | |
| M-TGDDM | M-TGDDM | 9-70 | 60 |
| TGDDM based resin | TGDDM | 0-35 | 0 |
| Curative | MDEA | 15-40 | 25 |
| Curative | MMIPA | 5-25 | 15 |
| Composition 8 | | | |
| M-TGDDM | M-TGDDM | 9-50 | 20 |
| TGDDM based resin | TGDDM | 0-20 | 10 |
| Multifunctional resin | TGPAP | 20-40 | 30 |
| Toughener | PES | 5-30 | 15 |
| Curative | 3,3-DDS | 10-35 | 20 |
| Curative | 4,4-DDS | 0-5 | 5 |
| Composition 9 | | | |
| M-TGDDM | M-TGDDM | 9-75 | 55 |
| TGDDM based resin | TGDDM | 0-35 | 0 |
| Toughener | PES | 5-25 | 15 |
| Curative | MDEA | 5-25 | 15 |
| Curative | MCDEA | 5-25 | 15 |
| Composition 10 | | | |
| M-TGDDM | M-TGDDM | 9-35 | 20 |
| TGDDM based resin | TGDDM | 0-15 | 0 |
| Multifunctional resin | TGPAP | 5-20 | 10 |
| Difunctional resin | Bisphenol F | 10-30 | 20 |
| Toughener | PES | 5-25 | 15 |
| Toughener | Polyamide | 5-25 | 15 |
| Curative | 4,4-DDS | 10-30 | 20 |
| Composition 11 | | | |
| M-TGDDM | M-TGDDM | 9-60 | 40 |
| TGDDM based resin | E-TGDDM | 0-35 | 20 |
| Toughener | Core shell impact | 1-10 | 5 |
| | modifier | | |
| Curative | MCA | 20-45 | 30 |
| Curative | DETDA | 0-10 | 5 |
| Composition 12 | | | |
| M-TGDDM | M-TGDDM | 9-80 | 60 |
| TGDDM based resin | TGDDM | 0-30 | 10 |
| Multifunctional resin | TGPAP | 0-15 | 5 |
| Toughener | Polyetherimide | 5-30 | 15 |
| Curative | Diuron | 1-15 | 5 |
| Curative | Dicyandiamide | 1-15 | 5 |
| Composition 13 | | | |
| M-TGDDM | M-TGDDM | 9-60 | 25 |
| TGDDM based resin | TGDDM | 0-30 | 15 |
| Multifunctional resin | TGPAP | 15-40 | 25 |
| Difunctional resin | Bisphenol A | 5-25 | 10 |
| Toughener | PES | 5-30 | 15 |
| Curative | Diuron | 1-15 | 5 |
| Curative | Dicyandiamide | 1-15 | 5 |

* Core shell rubber comprises 25 wt % core shell rubber and 75 wt % bisphenol A epoxy resin (6.25 wt % by weight of the composition core shell rubber and 18.75 wt % by weight of the composition bisphenol A)

M-TGDDM—N,N,N′,N′-tetraglycidyl-4,4′-diamino-3,3′-dimethyldiphenylmethane
TGDDM—N,N,N′,N′-tetraglycidyl-4-4-diaminodiphenylmethane (TGDDM)
E-TGDDM—N,N,N′,N′-tetraglycidyl-4-4′-diethyl-3-3′-diaminodiphenylmethane
Diuron—3-(3,4-dichlorophenyl)-1,1-dimethylurea
TGPAP—triglycidyl-p-aminophenol
TGMAP)—triglycidyl m-aminophenol
PES—polyethersulfone
ADH—Adipic dihydrazide
MMIPA—4,4-methylene bis (2-isopropyl-6-methyleneaniline)
MDEA—4,4-methylene bis (2,6-diethylaniline)
MCDEA—4,4-methylene bis (3-chloro-2,6-diethylaniline)
MCA—4,4′-methylene bis (2-chloroaniline)
DETDA—Diethyltoluenediamine

The above compositions all have improved compression characteristics, both in resin form and when used to form cured composite materials, compared to the corresponding resins in which the M-TGDDM is replaced by an equal amount of TGDDM.

### EXAMPLES

Three batches of M-TGDDM were tested and were found to have viscosities of 2205 mPa·as, 2821 mPa·s and 2150 mPa·s respectively at 50° C., compared to a viscosity of 3000 TO 6000 mPa·s at 50° C. for commercial samples of TGDDM. This reduced viscosity is an advantage for resin transfer moulding formulations, because, for example, formulations containing the M-TGDDM will have lower viscosity at injection temperatures.

Various stoichiometric combinations of TGDDM based resins and aromatic amine curing agents were produced and cured at 180° C. for 2 hours. Differential scanning calorimetry (DSC) was performed using a TA Discovery instrument to determine, uncured Tgs, peak of cure temperatures and reaction enthalpies using a heating rate of 10° C./min, and the results are listed below in Table 1.

TABLE 1

| | Uncured Tg | Peak of cure | Enthalpy |
|---|---|---|---|
| Formulation | (° C.) | (° C.) | (J/g) |
| TGDDM + 44DDS | −9 | 235 | 629 |
| M-TGDDM + 44DDS | −12 | 249 | 573 |
| E-TGDDM + 44DDS | −25 | 261 | 550 |
| TGDDM + 33DDS | −10 | 218 | 663 |
| M-TGDDM + 33DDS | −15 | 231 | 531 |
| TGDDM + MDEA | −15 | 240 | 450 |
| M-TGDDM + MDEA | −20 | 266 | 380 |

Table 1 shows that using M-TGDDM in place of TGDDM decreases reactivity as shown by the increase in peak of cure temperature when using the same curative. For example, M-TGDDM/44DDS has a peak of cure temperature 14° C. higher than TGDDM/44DDS. M-TGDDM has lower uncured Tgs than TGDDM, which is due to the lower viscosity of M-TGDDM. This lower viscosity would allow greater addition of solid components such as PES than TGDDM thereby increasing mechanical performance.

Further stoichiometric combinations of TGDDM and M-TGDDM with various curing agents were produced and cured at 180° C. for 2 hours. Dynamic mechanical analysis (DMA) was performed using a TA Q800 instrument on cured resin to determine glass transition temperatures (E′) at a heating rate of 5° C./min and at a frequency of 1 Hz and using an amplitude of 30 μm. The results are shown in Table 2.

TABLE 2

| | Dry E′ Tg | Compression Modulus |
|---|---|---|
| Formulation | (° C.) | (GPa) |
| TGDDM + 33DDS | 210 | 4.54 |
| M-TGDDM + 33DDS | 202 | 5.28 |
| TGDDM + 44DDS | 255 | 3.85 |
| M-TGDDM + 44DDS | 255 | 4.55 |
| TGDDM + MDEA | 195-200 | 3.00 |
| M-TGDDM + MDEA | 193 | 3.61 |
| TGDDM + MDEA + MMIPA | 210 | 3.30 |
| M-TGDDM + MDEA + | 206 | 4.00 |
| MMIPA | | |

Table 2 shows that compared to TGDDM, the compression modulus of M-TGDDM is higher when using the same curatives by around 15-20%. The Tg performance of the M-TGDDM resin is more or less the same as TGDDM.

The following formulations were produced and tested for resin and composite properties following curing for 2 hours at 180° C. The tests included neat resin compression modulus, open hole compression gross strength and filled hole compression gross strength. Neat resin compression modulus was performed using an Instron mechanical test machine on neat resin cylinders (60-70 mm in length and 12-14 mm in diameter) that were machined to parallel ends. The results are shown in Table 3.

| Formulation 1 | | |
|---|---|---|
| TGDDM | 60 | wt % |
| 4,4-methylene bis (2,6-diethylaniline) (MDEA) | 27 | wt % |
| 4,4-methylene bis (2-isopropyl-6-methyleneaniline) | 13 | wt % |
| (MMIPA) | | |
| Formulation 2 | | |
| TGDDM | 38 | wt % |
| E-TGDDM | 21 | wt % |
| 4,4′-methylene bis (2-chloroaniline) | 34 | wt % |
| Diethyltoluenediamine (DETDA) | 4 | wt % |
| Core shell impact modifier | 3 | wt % |
| Formulation 3 | | |
| M-TGDDM | 60.6 | wt % |
| 4,4′-methylene bis (2-chloroaniline) | 32.8 | wt % |
| Diethyltoluenediamine (DETDA) | 3.6 | wt % |
| Core shell impact modifier | 3.0 | wt % |

TABLE 3

| | Neat resin | | |
|---|---|---|---|
| | compression | OHC gross | FHC gross |
| Formulation | modulus (GPa) | strength (MPa) | strength (MPa) |
| Formulation 1 | 3.30 | 280 | 394/426 |
| Formulation 2 | 3.67 | 281 | 404 |
| Formulation 3 | 3.92 | 310 | 452 |

Table 3 shows that Formulation 3 containing M-TGDDM has a high neat resin compression modulus vale of 3.92. This high value translates to high OHC and FHC values in composite; whereas Formulation 1 and Formulation 2 (based on TGDDM) have similar OHC and FHC values even though the neat resin modulus values of Formulation 2 is higher than Formulation 3.

A further formulation based on a mixture of TGDDM and M-TGDDM was produced as follows:

Formulation 4

| | | |
|---|---|---|
| TGDDM | 38.1 | wt % |
| M-TGDDM | 20.6 | wt % |
| 4,4′-methylene bis (2-chloroaniline) | 34.3 | wt % |
| Diethyltoluenediamine (DETDA) | 3.4 | wt % |
| Core shell impact modifier | 3.6 | wt % |

The viscosities of Formulations 3 and 4 were measured under isothermal conditions at 110° C., using a parallel plate rheometer configuration, and both were found to have similar viscosities after 100 minutes. However, Formulation 3, containing only M-TGDD as the epoxy resin, has longer pot-life than Formulation 4, which contains both TGDDM and M-TGDDM. This allows for a longer injection window for RTM formulations.

1. A resin composition for producing a composite part, comprising:
a) from 30 to 90 wt % by weight of the composition of an epoxy resin component; and
b) from 5 to 50 wt % by weight of the composition of a curative component;
wherein the epoxy resin component comprises N,N,N′,N′-tetraglycidyl-4,4′-diamino-3,3′-dimethyldiphenylmethane (M-TGDDM) in an amount of at least 30 wt % by weight of the epoxy resin component;
and wherein the curative component comprises one or more of a diaminodiphenyl sulfone, a diaminobenzophenone, a fluorene diamine, a methylene bis aniline, or a substituted diamine toluene.

2. The composition according to claim 1, wherein the epoxy resin component comprises from to 65 wt % of said composition.

3. (canceled)

4. The composition according to claim 2, wherein said composition comprises at from 20 to 60 least 10 wt % by weight M TGDDM.

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)
